(19) United States
(12) Patent Application Publication
(10) Pub. No.: US 2021/0323133 A1
(43) Pub. Date: Oct. 21, 2021

(54) Hammer With Handle Balance

(71) Applicant: APEX BRANDS, INC., Apex, NC (US)

(72) Inventors: Nicholas Ryan Imsand, Huntersville, NC (US); Ian Cunningham, Apex, NC (US)

(21) Appl. No.: 17/232,286

(22) Filed: Apr. 16, 2021

Related U.S. Application Data
(60) Provisional application No. 63/013,200, filed on Apr. 21, 2020.

(51) Int. Cl. B25D 1/00

(52) U.S. Cl. CPC B25D 1/00; B25D 2250/005; B25D 2250/391

(57) ABSTRACT

A hand tool may include a head, a handle and one or more instances of an adjustable weight. The head may include a bell and a face for delivering an impact. The handle may be operably coupled to the head and extend linearly away from the head along an axis. The adjustable weight may be positionable on the head and/or the handle at a selected one of a plurality of different locations relative to the axis such that the hand tool is configurable to adjust both a striking power and a swinging balance of the hand tool.

### TECHNICAL FIELD

Example embodiments generally relate to hand tools and, in particular, relate to a hammer that is structured to provide improved handle balance.

### BACKGROUND

Hand tools are commonly used across all aspects of industry and in the homes of consumers. Hand tools are employed for multiple applications including, for example, tightening, component joining, and/or the like. For some joining applications, a hammer, and particularly a hammer and nails, may be used. However, hammers are used in many other contexts as well, and are a tool that has been in use by humans for many thousands of years.

The history of hammers, like so many other tools, is a tale of continuous improvement as better materials and ways of employing those materials have advanced. From stone hammer heads with bone or wooden handles, to the replacement of the stone with stronger and stronger metals, hammers evolved significantly. Later, to improve durability, the entire hammer (i.e., the head and the handle, began to be made from metallic materials. However, in spite of the great improvement in durability, the weight of such devices and the cost in terms of relatively expensive metallic materials demanded yet further improvement.

Modern hammers are often made with combinations of materials that are meant to balance the cost and durability. However, even these modern hammers can suffer from rigid design criteria that favor one user, but not others. For example, one user may find the handle balance in a particular hammer to feel comfortable and natural, while another user may find the exact same hammer to feel awkward in his/her hand. Unfortunately, for conventional hammers, customization of a single hammer for satisfactory employment by multiple different users is simply not practical.

### BRIEF SUMMARY OF SOME EXAMPLES

In an example embodiment, a hand tool may be provided. The hand tool may include a head, a handle and one or more instances of an adjustable weight. The head may include a bell and a face for delivering an impact. The handle may be operably coupled to the head and extend linearly away from the head along an axis. The handle may include a grip portion and a beam. The beam may extend from the head to the grip portion. The adjustable weight may be configured to be dynamically positioned on the beam at various positions along or relative to the axis.

In another example embodiment, a hand tool may be provided. The hand tool may include a head, a handle and one or more instances of an adjustable weight. The head may include a bell and a face for delivering an impact. The handle may be operably coupled to the head and extend linearly away from the head along an axis. The adjustable weight may be positionable on the head and/or the handle at a selected one of a plurality of different locations relative to the axis such that the hand tool is configurable to adjust both a striking power and a swinging balance of the hand tool.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a side view of a reconfigurable hammer or similar impact delivering hand tool according to an example embodiment;

FIG. 2 is a front view of the reconfigurable hammer of FIG. 1 in accordance with an example embodiment;

FIG. 3 is top view of the reconfigurable hammer of FIG. 1 in accordance with an example embodiment;

FIG. 4 a side view of various positions at which an adjustable weight can be added to the hammer to change the swinging balance in accordance with an example embodiment;

FIG. 5 illustrates a side view of the head of the hammer with a removable plug that can be used to alter the striking power of the hammer in accordance with an example embodiment; and

FIG. 6 illustrates a side view of the hammer with the removable plug removed so that weight slugs can be added to a recess in the hammer in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, some example embodiments may relate to the provision of a hand tool (e.g., a hammer) with an improved design that provides for the introduction of re-configurability into design of the hammer, particularly in relation to achieving handle balance. In this regard, for example, dynamically adjustable or repositionable weights may be provided for selective insertion into a beam portion (or simply, the “beam”) of the handle, which may extend from the eye portion of the head to the grip portion. In some cases, the grip portion may also include balance weights that can be selectively added, and/or balance weights could be added to the head of the hammer. In any case, the ability to dynamically configure the hammer may be provided so that any user can adjust the handle balance of the hammer and find a comfortable fit tailored to his/her preferences.

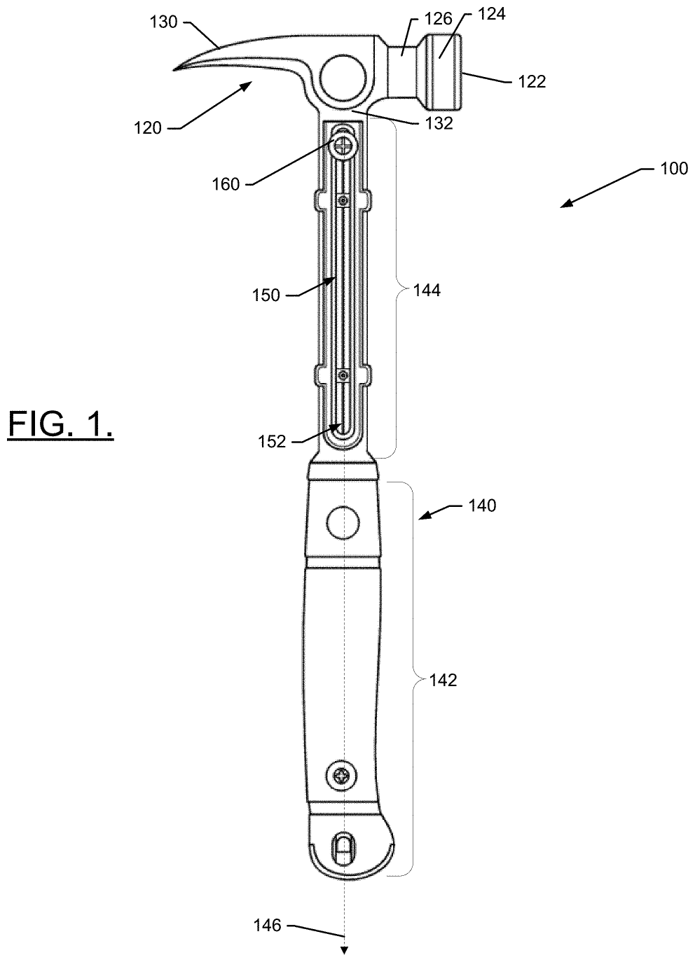

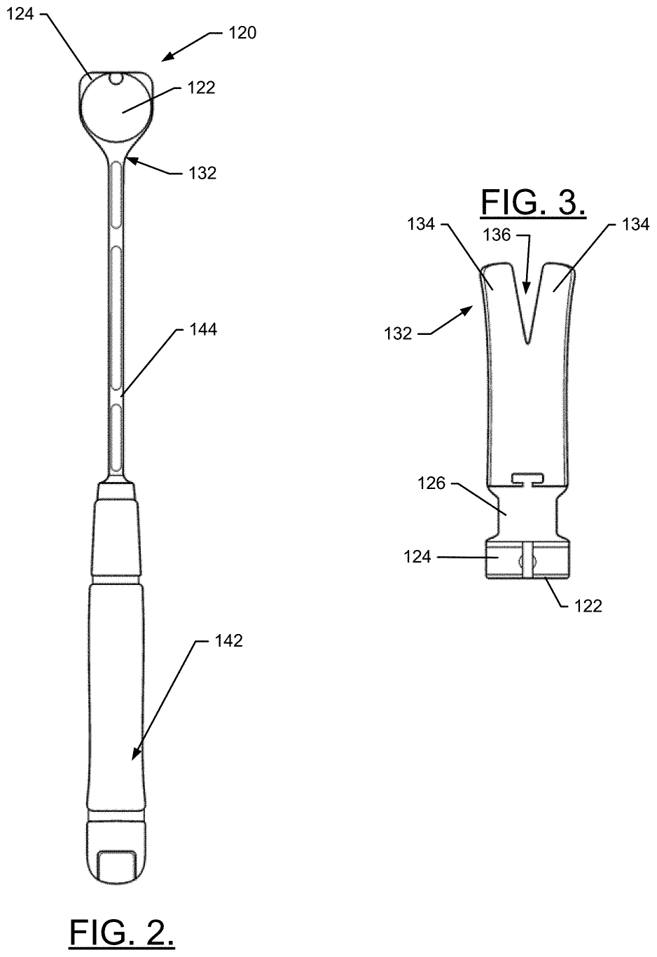

FIGS. 1-6 illustrate various views and configurations associated with a hammer 100 according to an example embodiment. In this regard, FIG. 1 illustrates a side view of the hammer 100 of an example embodiment. Meanwhile, FIG. 2 illustrates a front view, and FIG. 3 illustrates a top view of the hammer 100. The metallic base of the hammer 100 may be cast or forged as a single unitary piece. The hammer 100 may include two general assemblies in the form of a head 120, at which impacts are delivered to an object such as a nail, and a handle 140.

The head 120 may include a number of parts such as, for example, a face 122, which forms the striking surface of the hammer 100, and which is disposed at a distal end of a bell 124 of the head 120. A neck or throat 126 may connect the bell 124 to the remainder of the head 120. Opposite the face 122 (and therefore at a rear end of the head 120), the head 120 may further include a claw 130. The bell 124 may be separated from the claw 130 by an eye portion 132. The lateral side of the head 120 (i.e., between the claw 130 and the bell 124, and above the eye portion 140) may be referred to as a cheek. The eye portion 140 may correspond to the eye that typically received the handle when the handle was made of a separate component or material from the head 120. However, as noted above, in this case the metallic base of the hammer 100 is a single unitary piece, so the eye portion 132 simply correlates to the location of the eye on a conventional multi-piece hammer, but does not necessarily function as such.

The claw 130 may include two laterally extending claw members 134 having a nail slot 136 formed therebetween. The head of a nail can be placed in the nail slot 136 and the claw members 134 may engage the head such that when the hammer 100 is pivoted about the eye portion 132, leverage is placed on the nail to remove the nail from the medium into which it had been driven. The claw 130 may have other uses as well, often related to prying. It should also be appreciated that the claw 130 may be replaced by a peen in some cases, and thus the particular design of the head 120 may be different in some cases without impacting other aspects of example embodiments.

The handle 140 may include a grip portion 142 and a beam portion (or beam 144). The beam 144 may extend from the eye portion 132 (at a proximal end of the beam 144) to the grip portion 142 (at a distal end of the beam 144). Thus, a proximal end of the grip portion 142 may be attached to a distal end of the beam 144, and a distal end of the grip portion 142 may extend away from the eye portion 132 and the beam 144 in alignment with the beam 144. The grip portion 142 and the beam 144 may therefore have a longitudinal centerline (or axis 146) that is common and extends away from the eye portion 132.

In some cases, both the grip portion 142 and the beam 144 may be substantially rectangular metallic plate portions, and only the grip portion 142 may include additional molded or fitted material (i.e., forming the grip) disposed over the metallic plate portions. In some cases, portions of the head 120 such as the bell 124, the cheeks, the claw 130 and the eye portion 132 may be polished, and remaining visible portions of the head 120 and the beam 144 may be coated or painted.

In an example embodiment, at least the beam 144 (and in some cases both the beam 144 and the grip portion 142) may include one or more axial passageways 150. The axial passageways 150 of this example are formed as longitudinally extending slots that are parallel to (and extend along) the axis 146. In this example, there are five distinct axial passageways 150 that are each formed as longitudinally extending slots. However, it may alternatively be possible to include fewer or more axial passageways 150 in some embodiments. Thus, for example, the axial passageways 150 could be replaced by one longitudinally extending slot extending from the proximal end of the beam 144 to the distal end of the grip portion 142. Alternatively, a single longitudinally extending slot could be provided in each of the beam 144 and the grip portion 142. As yet another alternative, the a large number of small axial passageways (including circular or other shaped axial passageways) could be formed in the beam 144 (and/or the grip portion 142). In any case, the axial passageways 150 may define an opening through the beam 144 in a direction substantially perpendicular to the axis 146. Thus, to the extent a width of the beam 144 and/or grip portion 142 is wider than a thickness thereof, it should be appreciated that opposing faces of the beam 144 and/or grip portion 142 that have a wider dimension (i.e., the width dimension) may lie substantially parallel to each other and the axial passageways 150 may pass through these opposing faces in a direction substantially perpendicular thereto.

Although the axial passageways 150 may remain empty, some example embodiments may at least partially fill the axial passageways 150 with foam, rubber or another insulating or dampening material. However, in some cases, even such insulating or dampening material may have a slot 152 formed therein. In this example, the slot 152 extends in substantial alignment with the axis 146, but no such alignments is necessarily required. The insulating or dampening material may be provided for aesthetic reasons, or to reduce sound and/or vibration generated in the handle 140 when the hammer 100 is in use.

As shown in FIG. 1, an adjustable weight 160 can be attached to the beam 144. In this regard, for example, the adjustable weight 160 may be embodied as movable slugs that can be affixed to the beam 144. For example, the adjustable weight 160 may be embodied as a nut/bolt combination, where a shaft of the bolt passes through the slot 152 at a selected location along the longitudinal length of the axial passageway 150. At the selected location, which is adjustable by moving the shaft higher or lower within the axial passageway 150 along the slot 152, the nut portion of the adjustable weight 160 may be tightened onto the bolt to affix the adjustable weight at the selected location. In the example of FIG. 1, a head (i.e., a cross-head in this example, but equally capable of having a slotted head, hex head, star shape or any other suitable shape) of the adjustable weight 160 is shown, so it should be appreciated that a bolt may be located on the opposing side (and not visible in this view). The shaft of the adjustable weight 160 therefore passes directly away from the viewer (in a direction into the page) and engages the bolt on the other side of the beam 144. The bolt may be held (either manually or due to being shaped to be held in the axial passageway 150 in a manner that prevents rotation) while a cross-head screwdriver is used to tighten the head onto the bolt. This process may be reversed to loosen the bolt and allow the selected location to be changed before retightening the bolt.

It should also be appreciated that other fixing means for attaching the adjustable weight 160 to the beam 144 could be used in alternative embodiments. Moreover, while the depicted example allows infinite adjustment of the location of the adjustable weight 160 along the length of the beam 144, other examples could include a number of specific locations along the beam 144 at which affixing could occur. In those examples, although adjustability and dynamic repositioning of the selected location of the adjustable weight 160 is still possible, the adjustability may be limited to discrete locations instead of being infinitely adjustable.

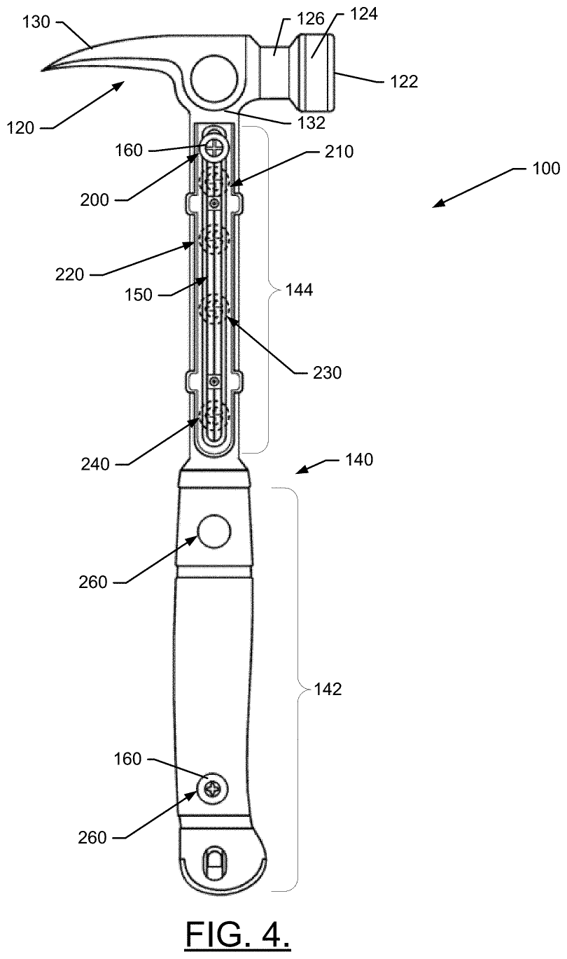

Different users will naturally grasp the hammer 100 at different parts of the grip portion 142. Moreover, different users may have different hand sizes, and different techniques for delivering a strike using the hammer 100. Accordingly, the swing balance experienced by each user could be slightly different. By changing the selected location at which the adjustable weight 160 is attached to the beam 144, the swing balance of the hammer 100 can be adjusted. FIG. 4 illustrates the adjustable weight 160 at a first selected location 200 proximate to the eye portion 132. However, FIG. 4 also shows a second selected location 210 slightly farther away from the eye portion 132, along with a third selected location 220, a fourth selected location 230 and a fifth selected location 240 each of which is progressively located farther away from the eye portion 132 (and therefore closer to the grip portion 142).

As can be appreciated from FIG. 4, each of the first, second, third, fourth and fifth selected locations 200, 210, 220, 230 and 240 is one of an infinite number of dynamically adjustable positions at which the adjustable weight 160 can be applied. Moreover, more than one instance of the adjustable weight 160 could be applied in some cases. Thus, for example, one instance of the adjustable weight 160 could be applied at the first selected location 200 and another adjustable weight 160 could be applied at the second selected location 210 (or any of the other selected locations). The user may therefore have a wide range of options available to configure the hammer 100 in a desirable way for achieving swing balance that feels comfortable to the user. However, although the beam 144 may be particularly useful (due to the accessibility of the axial passageway 150) for affixing the adjustable weight 160 to infinitely selectable locations for achieving balance, other options for weight balancing may also be available.

In this regard, as also shown in FIG. 4, the grip portion 142 may include one or more fixed retainers 260 disposed at selected locations in the grip portion 142. In this example, one fixed retainer 260 is located higher on the grip portion 142 (e.g., near the proximal end of the grip portion 142 and close to the beam 144) while another instance of the fixed retainer 260 is located lower on the grip portion 142 (e.g., near the distal end of the grip portion 142 and farther away from the beam 144). The user may opt to place the adjustable weight 160 (or another instance of the adjustable weight 160) in one or both of the fixed retainers 260.

The fixed retainers 260 may represent depressions or orifices formed in the material forming the grip of the handle 140 along the grip portion 142. The depressions or orifices may enable the adjustable weight 160 to be attached to the grip portion 142 at these locations in a manner similar to that described above. In the example of FIG. 4, another instance of the adjustable weight 160 is disposed in the fixed retainer 260 that is located near the distal end of the grip portion 142. However, the other fixed retainer 260 (or both fixed retainers 260) could alternatively retain an instance of the adjustable weight 160 therein in alternative embodiments.

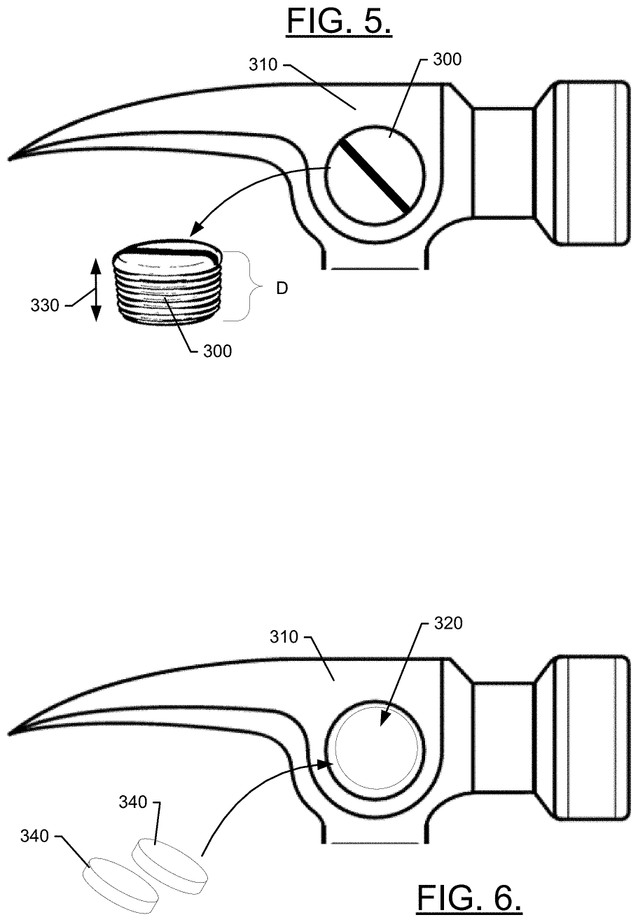

The application of weight could also be applied to the head 120 in some cases. In such examples, the location may be fixed (e.g., a specific location within the head 120), but the amount of weight could be altered. This type of balance adjustment could also be performed in a number of different ways. For example, as shown in FIGS. 5 and 6, a removable plug 300 may be provided in a cheek 310 of the head 120 of the hammer 100. The removable plug 300 of this example is threaded about a periphery thereof, and is configured to engage threads formed in a recess 320 provided in either one or both of the cheeks 310. In some cases, the removable plug 300 may itself act as a weight. Thus, for example by increasing or decreasing a depth (D) of the removable plug (as shown by arrow 330), more or less weight could be added to the head 120. If each one of the cheeks 310 had a corresponding instance of the recess 320 and removable plug 300, plugs having the same size and weight could be installed on each side to ensure symmetrical weighting.

Alternatively, after the removable plug is removed (as shown in FIG. 6), one or more instances of a weighted slug 340 may be inserted into the recess 320 before the removable plug 300 is replaced. The additional weight provided by the weighted slug(s) 340 may alter the balance of the head 120 and either or both of the swinging balance of the hammer 100 (e.g., by moving more weight along the axis 146 of the hammer 100), and the striking power of the hammer 100 (due to the increased weight in the head 120). Thus, for example, each of the weighted slugs 340 may have a corresponding weight (e.g., 2 ounces, 4 ounces or the like) to enable the hammer 100 to be configured in a particular configuration (e.g., 16 ounce, 20 ounce or 24 ounce).

Accordingly, as can be appreciated from the examples above, in addition to providing options for providing swinging balance for the hammer 100 by moving the locations at which weights are distributed along the axis 146, the striking power of the hammer 100 can also be adjusted by putting more or less weight in the head 120 of the hammer 100. Thus, for example, a hand tool of an example embodiment may include a head, a handle and one or more instances of an adjustable weight. The head may include a bell and a face for delivering an impact. The handle may be operably coupled to the head and extend linearly away from the head along an axis. The adjustable weight may be positionable on the head and/or the handle at a selected one of a plurality of different locations relative to the axis such that the hand tool is configurable to adjust both a striking power and a swinging balance of the hand tool.

The hand tool may include a number of modifications, augmentations, or optional additions, some of which are described herein. The modifications, augmentations or optional additions may be added in any desirable combination. For example, handle may include a grip portion and a beam. The beam may extend from the head to the grip portion. The adjustable weight may be configured to be affixed on the beam at the selected one of the plurality of different locations along the axis. In an example embodiment, the beam may include an axial passageway defining an opening through the beam in a direction substantially perpendicular to the axis, and the adjustable weight may be configured to pass through the axial passageway. In some cases, the adjustable weight may be fixable at an infinite number of positions along the axis within the axial passageway. In an example embodiment, the adjustable weight may be fixable at a plurality of discrete positions along the axis within the axial passageway. In some cases, the grip portion may include one or more fixed retainers, and the adjustable weight may be further configured to be fixable in at least one of the one or more fixed retainers. In an example embodiment, the head of the hand tool may be further configured to have an adjustable weight. In some cases, the head of the hand tool may include a recess formed in a cheek of the head, and the hand tool may further include a removable plug configured to be disposed in the recess. In an example embodiment, the removable plug may be one of a plurality of different removable plugs, each of which has a different weight, and a striking power of the hand tool may be adjustable based on which one of the different weights is selected for insertion in the recess as the removable plug. In some cases, the removable plug may be configured to be removed to enable one or more weighted slugs to be disposed in the recess to adjust a striking power of the hand tool.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A hand tool comprising:
a head having a bell and a face for delivering an impact;
a handle operably coupled to the head and extending linearly away from the head along an axis; and
one or more instances of an adjustable weight,
wherein the handle comprises a grip portion and a beam, the beam extending from the head to the grip portion, and
wherein the adjustable weight is configured to be dynamically positioned on the beam at various positions along the axis.

2. The hand tool of claim 1, wherein the beam comprises an axial passageway defining an opening through the beam in a direction substantially perpendicular to the axis, and
wherein the adjustable weight is configured to pass through the axial passageway.

3. The hand tool of claim 2, wherein the adjustable weight is fixable at an infinite number of positions along the axis within the axial passageway.

4. The hand tool of claim 2, wherein the adjustable weight is fixable at a plurality of discrete positions along the axis within the axial passageway.

5. The hand tool of claim 1, wherein the grip portion comprises one or more fixed retainers, and
wherein the adjustable weight is further configured to be fixable in at least one of the one or more fixed retainers.

6. The hand tool of claim 5, wherein the head of the hand tool is further configured to have an adjustable weight.

7. The hand tool of claim 1, wherein the head of the hand tool comprises a recess formed in a cheek of the head, and
wherein the hand tool further comprises a removable plug configured to be disposed in the recess.

8. The hand tool of claim 7, wherein the removable plug is one of a plurality of different removable plugs, each of which has a different weight, and
wherein a striking power of the hand tool is adjustable based on which different weight is selected for insertion in the recess as the removable plug.

9. The hand tool of claim 7, wherein the removable plug is configured to be removed to enable a weighted slug to be disposed in the recess to adjust a striking power of the hand tool.

10. The hand tool of claim 9, wherein a plurality of weighted slugs are configured to be disposed in the recess to adjust a striking power of the hand tool.

11. A hand tool comprising:
a head having a bell and a face for delivering an impact;
a handle operably coupled to the head and extending linearly away from the head along an axis; and
one or more instances of an adjustable weight,
wherein the adjustable weight is positionable on the head and/or the handle at a selected one of a plurality of different locations relative to the axis such that the hand tool is configurable to adjust both a striking power and a swinging balance of the hand tool.

12. The hand tool of claim 11, wherein the handle comprises a grip portion and a beam, the beam extending from the head to the grip portion, and
wherein the adjustable weight is configured to be affixed on the beam at the selected one of the plurality of different locations along the axis.

13. The hand tool of claim 12, wherein the beam comprises an axial passageway defining an opening through the beam in a direction substantially perpendicular to the axis, and
wherein the adjustable weight is configured to pass through the axial passageway.

14. The hand tool of claim 13, wherein the adjustable weight is fixable at an infinite number of positions along the axis within the axial passageway.

15. The hand tool of claim 13, wherein the adjustable weight is fixable at a plurality of discrete positions along the axis within the axial passageway.

16. The hand tool of claim 12, wherein the grip portion comprises one or more fixed retainers, and
wherein the adjustable weight is further configured to be fixable in at least one of the one or more fixed retainers.

17. The hand tool of claim 16, wherein the head of the hand tool is further configured to have an adjustable weight.

18. The hand tool of claim 12, wherein the head of the hand tool comprises a recess formed in a cheek of the head, and
wherein the hand tool further comprises a removable plug configured to be disposed in the recess.

19. The hand tool of claim 18, wherein the removable plug is one of a plurality of different removable plugs, each of which has a different weight, and
wherein a striking power of the hand tool is adjustable based on which one of the different weights is selected for insertion in the recess as the removable plug.

20. The hand tool of claim 18, wherein the removable plug is configured to be removed to enable one or more weighted slugs to be disposed in the recess to adjust a striking power of the hand tool.
